(19) United States
(12) Patent Application Publication
(10) Pub. No.: US 2012/0170128 A1
(43) Pub. Date: Jul. 5, 2012

(54) OPTICAL PANEL

(75) Inventors: Guo-Chen Lee, Taoyuan (TW); Shin-Kun Lee, Taoyuan (TW); Chia-Chen Lee, Taoyuan (TW); I-Ping Huang, Taoyuan (TW); Tsung-Yung Hung, Taoyuan (TW)

(73) Assignee: GLOBAL LIGHTING TECHNOLOGIES INC., Taoyuan (TW)

(21) Appl. No.: 13/330,697

(22) Filed: Dec. 20, 2011

(30) Foreign Application Priority Data
Dec. 31, 2010 (TW) 99147319
Feb. 1, 2011 (TW) 100103977

(51) Int. Cl. G02B 27/12

(52) U.S. Cl. 359/619

(57) ABSTRACT

An optical panel with a surface is provided, in which the surface has a first direction and a second direction and an included angle is formed between the first direction and the second direction. The optical panel includes an optical element array and a rubbing portion. The optical element array is disposed on the surface of the optical panel and extended in the first direction. The rubbing portion is disposed on the surface of the optical panel and extended in the second direction, in which the surface includes an upper surface of the optical panel, a lower surface of the optical panel and a combination thereof.

### CROSS-REFERENCE TO RELATED APPLICATION

This application claims the priority benefits of Taiwan application serial no. 99147319, filed on Dec. 31, 2010 and Taiwan application serial no. 100103977, filed on Feb. 01, 2011. The entirety of each of the above-mentioned patent applications is hereby incorporated by reference herein and made a part of this specification.

### BACKGROUND OF THE INVENTION

1. Field of the Invention

The invention generally relates to an optical panel, a cutter, a cutter module and a fabrication method of the cutter, and more particularly, to an optical panel with good light diffusion effect, light-collecting effect or light enhancement effect and a cutter able to perform surface processing of various workpieces, a cutter module and a fabrication method of the cutter.

2.Description of Related Art

The optical panel with precision optical effect has become a technical product, upon which all the people focus attention. An optical panel can be used in various relevant optical fields. For example, in liquid crystal display (LCD) field, an optical panel such as diffusion plate to make light diffused, prism sheet able to collect light or brightness-enhancing sheet to advance planar light source's luminance is often utilized.

Usually, various optical micro-structures are fabricated on the surface of the above-mentioned optical panel (diffusion sheet, prism sheet or brightness-enhancing sheet) so as to achieve a required optical effect. In the prior art, the optical micro-structures are fabricated on the surface of the optical panel in thermal imprinting way. However, the thermal imprinting way has following disadvantage:

First, a thermal imprinting process must be performed in high-temperature atmosphere, so that the whole process must be accompanied with heating, which makes the process more complex and in risk. In addition, the optical micro-structures formed with thermal imprinting process would produce unexpected dimension discrepancy affected by hot-expansion and cold-shrinking nature after cooling. In short, the dimension precision of the optical micro-structures would be degraded, which leads to poor optical effect.

In addition, in the precision machining field, usually a cutter is used to perform cutting or relevant surface processing on various workpieces (for example, optical panel, metal panel and the like). Taking a surface processing of an optical panel as an example, in order to fabricate optical micro-structures on an optical panel, a single cutter would back-and-forth scribe the surface of the optical panel so as to form grooves. However, such technology has following advantage:

First, the lifetime of the single cutter is shortened. During scribing grooves, due to directly and continuously rubbing between the cutter and the optical panel, the cutter easily gets problems of wear, deformation, reduced hardness due to high-temperature and fracture; when the cutter is damaged, the precision of the scribed grooves is also correspondingly reduced, which makes the yield of the optical panel unable to be advanced.

Further, the above-mentioned processing is very slow, in which each groove needs a single cutter to ceaselessly move back and forth for scribing operation, so that when the quantity of the grooves is a lot or the area to be scribe is quite large, the whole processing would last for a long time. Although the period time for each traverse of the cutter can be shortened by increasing the machining speed, however, the cutter would produce instantaneous high-heat along with the high-speed moving thereof, which, on the contrary, results in a shorter lifetime of the cutter.

Moreover, the above-mentioned cutter is not suitable for machining micro-structures with special shape and massive production. When a user wants to fabricate grooves with special geometric shape, different cutters are required and respectively switched. In more details, a first groove with a first micro-structure requires a first cutter for scribing, and a second groove with a second micro-structure requires a second tool for scribing, which would make machining path and tool-exchanging sequence of the cutter too complex to massively fabricate optical panels.

It can be seen from the depiction above, in precision machining field, it is necessary to develop a cutter able to solve the current problem.

### SUMMARY OF THE INVENTION

Accordingly, the invention is directed to an optical panel which has an optical element array and a rubbing portion able to advance the optical effect of the optical panel.

The invention is also directed to a cutter able to perform cutting or surface processing operation and meanwhile fabricate micro-structures on the surface of a workpiece.

The invention is further directed to a cutter module which has a plurality of the above-mentioned cutters.

The invention is yet further directed to a fabrication method of cutter able to fabricate the above-mentioned cutter.

The invention provides an optical panel having a surface which has a first direction and a second direction and an included angle is formed between the first direction and the second direction. The optical panel includes an optical element array and a rubbing portion. The optical element array is disposed on the surface of the optical panel and extended in the first direction. The rubbing portion is disposed on the surface of the optical panel and extended in the second direction. The surface includes an upper surface of the optical panel, a lower surface of the optical panel and a combination thereof.

In an embodiment of the invention, the above-mentioned rubbing portion is distributed on a same horizontal/vertical base line of the surface or on different horizontal/vertical base lines of the surface.

In an embodiment of the invention, the above-mentioned included angle is 90±10 degrees.

In an embodiment of the invention, the above-mentioned optical element array includes: a plurality of optical micro-structures protruded from the surface of the optical panel, and the shape of the optical micro-structures is selected from a semicircular shape, a V-shape, a R-recess shape or a combination thereof.

In an embodiment of the invention, the above-mentioned optical element array includes: a plurality of optical micro-structures concaved from the surface of the optical panel, and the shape of the optical micro-structures is selected from a semicircular shape, a V-shape, a R-recess shape or a combination thereof.

In an embodiment of the invention, the above-mentioned optical element array includes: a plurality of optical micro-structures, and dimensions of the optical micro-structures one another are the same or different.

In an embodiment of the invention, the above-mentioned optical element array includes: a plurality of optical micro-structures, and an interval between two adjacent optical micro-structures is the same or different.

In an embodiment of the invention, the above-mentioned optical panel includes diffusion sheet, diffusion plate, prism sheet or brightness-enhancing sheet.

The invention also provides an optical panel with a surface. The optical panel includes: a plurality of optical micro-structures and a rubbing portion. The optical micro-structures are distributed on the surface of the optical panel. The rubbing portion is distributed on the surface of the optical panel. The surface includes an upper surface of the optical panel, a lower surface of the optical panel and a combination thereof.

In an embodiment of the invention, the above-mentioned optical panel has a plurality of distribution regions, and the optical micro-structures are regularly or irregularly disposed in the distribution regions.

In an embodiment of the invention, the above-mentioned rubbing portion is distributed on a same horizontal/vertical base line of the surface or on different horizontal/vertical base lines of the surface.

In an embodiment of the invention, the above-mentioned optical micro-structures are protruded from the surface of the optical panel, and the shape of the optical micro-structures is selected from a semicircular shape, a V-shape, a R-recess shape or a combination thereof.

In an embodiment of the invention, the above-mentioned optical micro-structures are concaved from the surface of the optical panel, and the shape of the optical micro-structures is selected from a semicircular shape, a V-shape, a R-recess shape or a combination thereof.

In an embodiment of the invention, the dimensions of the above-mentioned optical micro-structures one another are the same or different.

In an embodiment of the invention, an interval between two adjacent above-mentioned optical micro-structures is the same or different.

In an embodiment of the invention, the above-mentioned optical panel includes diffusion sheet, diffusion plate, prism sheet or brightness-enhancing sheet.

The invention further provides a cutter, which includes a base portion, at least a cutting portion and a plurality of micro-structures. The base portion has a rotation axis. The cutting portion is disposed on the base portion and arranged along the extension direction of the rotation axis. The micro-structures are disposed on the cutting portion.

The invention yet further provides a cutter module, which includes a plurality of above-mentioned cutters, in which the cutters are arranged on the extension direction of the rotation axis.

The invention yet further provides a fabrication method of cutter, which includes following steps: providing a base portion with a rotation axis; providing at least a cutting portion disposed on the base portion and arranged along the extension direction of the rotation axis; providing a plurality of micro-structures disposed on the cutting portion.

In an embodiment of the invention, the above-mentioned cutting portion is coaxially arranged along the extension direction of the rotation axis.

In an embodiment of the invention, the above-mentioned cutting portion is spirally arranged along the extension direction of the rotation axis.

In an embodiment of the invention, the above-mentioned base portion and cutting portion are integrated formed.

In an embodiment of the invention, the above-mentioned base portion and cutting portion are assembled to each other.

In an embodiment of the invention, the above-mentioned micro-structures are protruded from the cutting portion and the shape of the micro-structures is selected from a semicircular shape, a V-shape, a R-recess shape or a combination thereof.

In an embodiment of the invention, the above-mentioned micro-structures are concaved from the cutting portion and the shape of the micro-structures includes semicircular shape, a V-shape, a R-recess shape or a combination thereof.

In an embodiment of the invention, the dimensions of the above-mentioned micro-structures one another are the same or different.

In an embodiment of the invention, the above-mentioned cutting portion is continuously or discontinuously disposed on the base portion.

In an embodiment of the invention, the above-mentioned cutting portion is discontinuously disposed on the base portion, and the cutting portions are multiple and assembled on the base portion along a same axis direction.

In an embodiment of the invention, the above-mentioned cutting portion is discontinuously disposed on the base portion, and the cutting portions are multiple and assembled on the base portion along different axis directions.

Based on the description above, the optical panel of the invention has an optical element array and a rubbing portion, in which the rubbing portion provides optical effect of hazing light. The optical element array includes a plurality of optical micro-structures disposed at same blocks or different blocks of a plurality of distribution regions. The required optical effect, such as diffusing light, collecting light and increasing luminance, can be produced according to the type and the disposing position of the optical micro-structures. In particular, the above-mentioned optical panel is fabricated with a cutter, so that the optical panel has optical characteristic structure of the rubbing portion. In comparison with the conventional thermal imprinting method, the optical micro-structures of the above-mentioned optical panel are not affected by hot-expansion and cold-shrinking nature after cooling. Thus, the dimension of the optical micro-structures has pretty high optical precision.

Moreover, the cutting portions of the cutter in the invention are arranged along the extension direction of the rotation axis of the base portion and a plurality of micro-structures are formed on each the cutting portion. In this way, during cutting or surface processing on a workpiece with a cutter, the processing efficiency of the cutter can be advanced. In addition, required any micro-structures can be formed on the workpiece by forming various micro-structures on each the cutting portion.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective schematic view of an optical panel which includes a schematic diagram showing an optical element array and a rubbing portion on a surface of the optical panel according to an embodiment of the invention.

FIG. 2 is a flowchart illustrating a fabricating method of the optical panel according to one embodiment of the present invention.

FIG. 3 is a schematic diagram of a cutter according to an embodiment of the invention.

FIG. 4 is a schematic diagram of another cutter according to an embodiment of the invention.

FIG. 5 is a schematic diagram of yet another cutter according to an embodiment of the invention.

FIG. 6 is a schematic diagram of micro-structures of a cutter according to an embodiment of the invention.

FIG. 7 is a schematic diagram of micro-structures of a cutter according to another embodiment of the invention.

FIG. 8 is a schematic diagram showing performing cutting on a workpiece by using a cutter of the embodiment of the invention.

FIG. 9 is a schematic diagram showing performing surface processing on an optical panel by using a cutter of the embodiment of the invention.

FIG. 10 is a schematic diagram showing performing surface processing on another optical panel by using a cutter of the embodiment of the invention.

FIG. 11A is a schematic diagram of a cutter according to yet another embodiment of the invention.

FIG. 11B is a schematic diagram of a cutter according to yet another embodiment of the invention.

FIG. 12 is a schematic diagram of a cutter module according to an embodiment of the invention.

FIG. 13 is a flowchart illustrating a fabricating method of cutter according to one embodiment of the present invention.

### DESCRIPTION OF THE EMBODIMENTS

### Optical Panel

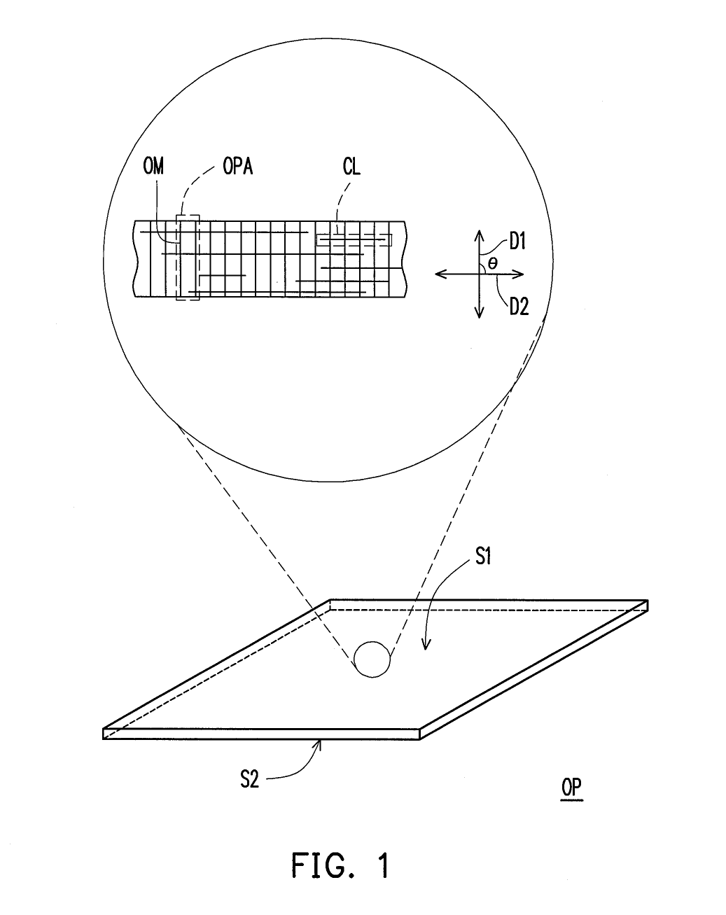

FIG. 1 is a perspective schematic view of an optical panel which includes a schematic diagram showing an optical element array and a rubbing portion on a surface of the optical panel according to an embodiment of the invention. Referring to FIG. 1, an optical panel OP has a surface S1 or S2, and the surface S1 or S2 has a first direction D1 and a second direction D2, and an included angle θ is formed between the first direction D1 and the second direction D2. As shown by FIG. 1, the surface S1 of the optical panel OP can be an upper surface and the surface S2 thereof can be a lower surface. The included angle θ can be 90±10 degrees, but preferably it is 90 degree.

Continuing to FIG. 1, the optical panel OP can include an optical element array OPA and a rubbing portion CL. The optical element array OPA is disposed on the surface S1 or S2 and extended in the first direction D1.

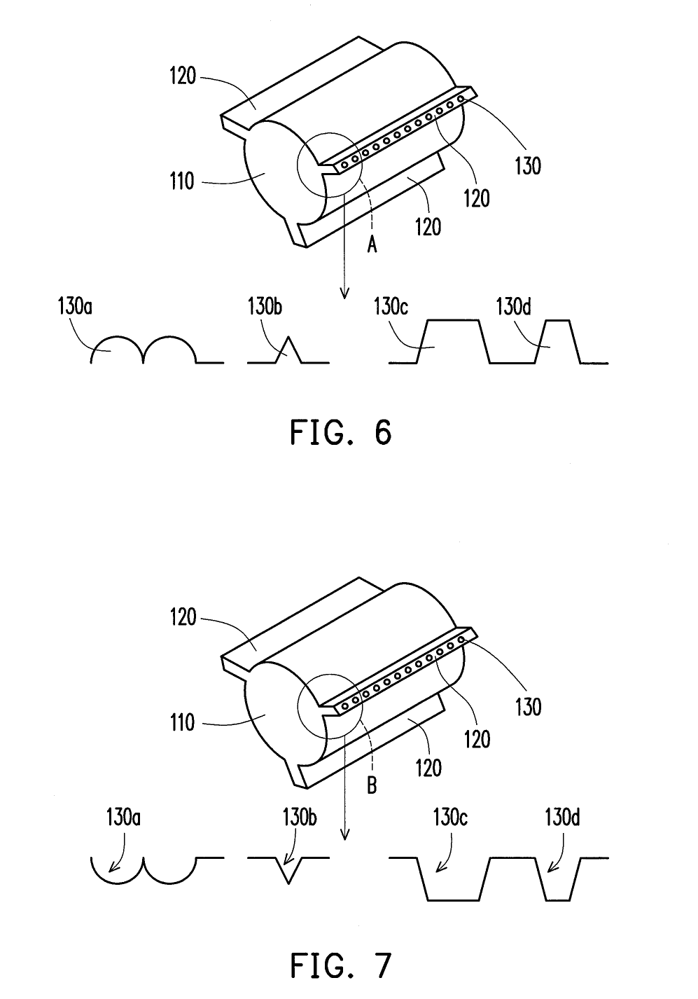

In more details, the optical panel OP can include a plurality of optical micro-structures OM concaved from the surface of the optical panel OP, and the shape of the optical micro-structures OM is selected from a semicircular shape, a V-shape, a R-recess shape or a combination thereof (complementary to the shapes of the micro-structures 130 protruded from the cutting portion 120 shown in following FIG. 6).

The optical panel OP can also include a plurality of optical micro-structures OM protruded from the surface of the optical panel OP, and the shape of the optical micro-structures OM is selected from a semicircular shape, a V-shape, a R-recess shape or a combination thereof (complementary to the shapes of the micro-structures 130 concaved from the cutting portion 120 shown in following FIG. 7). The dimensions of the optical micro-structures OM one another are the same or different, in which the same dimensions or the different dimensions mean the same areas or different areas, or the same volumes or different volumes. The optical element array OPA can be regularly or randomly arranged on the surface S1 or S2 of the optical panel OP, depending on the required optical effect. In addition, an interval (not shown) between two adjacent optical micro-structures OM is the same or different.

As shown in FIG. 1, the rubbing portion CL is disposed on the surface S1 or S2 of the optical panel OP and extended in the second direction D2. In more details, the optical element array OPA and the rubbing portion CL can be formed on at least one surface S1 or S2 or all the surfaces S1 and S2 of the optical panel OP.

The rubbing portion CL can be randomly distributed on the surface S1 or S2, i.e. distributed on a same horizontal/vertical base line (not shown) or different horizontal/vertical base lines of the surface S1 (or S2). In more details, the surface S1 (or S2) can have a plurality of horizontal base lines, and rotating the horizontal base lines into 90 degrees can form a plurality of vertical base lines. The rubbing portion CL can be located at positions on a same horizontal base line (regularly disposing), or located at positions on different horizontal base lines (randomly disposing). By means of disposing the rubbing portion CL, an optical effect of hazing surface is achieved.

The type of the above-mentioned optical panel OP can be selected depending on the required optical effect. In an embodiment, the optical micro-structures OM have irregular shapes so as to diffuse light, and at the time, the optical panel OP functions as a diffusion plate (or a diffusion sheet) able to scatter light; or the optical micro-structures OM have pyramid shapes so as to refract light, and at the time, the optical panel OP functions as a prism sheet; or the optical micro-structures OM have semicircular column shapes so as to collect light, and at the time, the optical panel OP functions as a brightness-enhancing sheet.

In following, a fabrication method of the above-mentioned optical panel of the invention is depicted.

### Fabrication Method of Optical Panel

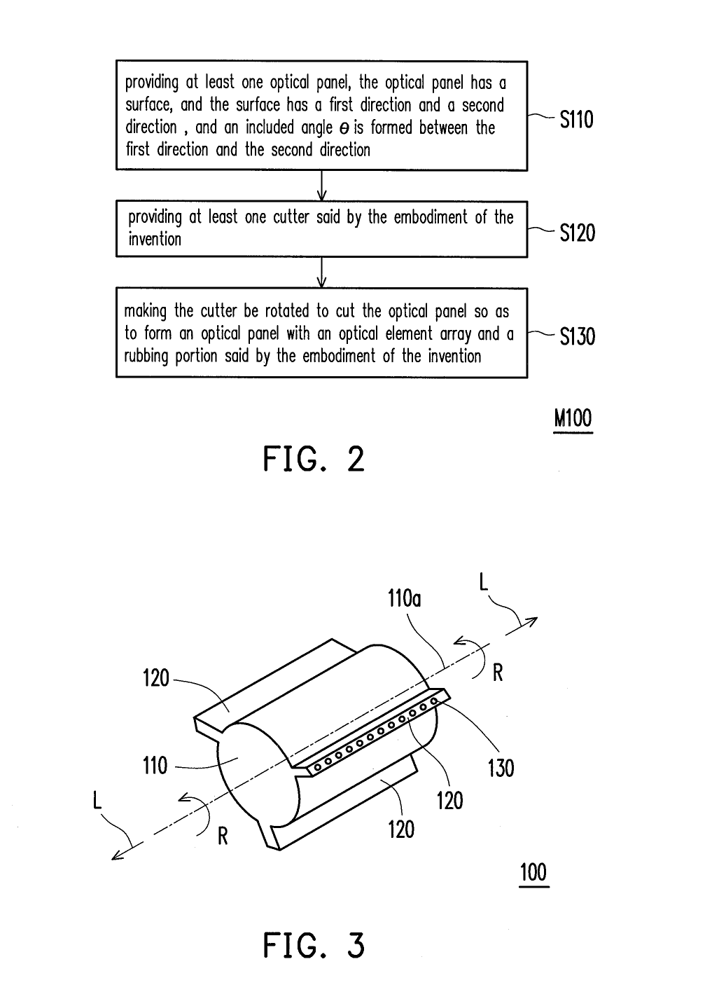

FIG. 2 is a flowchart illustrating a fabricating method of the optical panel according to one embodiment of the present invention. FIG. 3 is a schematic diagram of a cutter according to an embodiment of the invention. Referring to FIGS. 1-3, the fabrication method of optical panel M100 can be understood with the figures. The fabrication method of optical panel M100 includes steps S110-S130, as shown by FIG. 2.

First in step S110, at least one optical panel OP shown by FIG. 1 is provided. The optical panel OP has a surface S1 or S2, and the surface S1 or S2 has a first direction D1 and a second direction D2, and an included angle θ is formed between the first direction D1 and the second direction D2.

Next in step S120, at least one cutter 100 as shown by FIG. 3 is provided, in which each cutter 100 includes a base portion 110, at least one cutting portion 120 (there are three ones in FIG. 3 as example) and a plurality of micro-structures 130. The base portion 110 has a rotation axis 110a. The cutting portions 120 are disposed on the base portion 110 and arranged along the extension direction L of the rotation axis 110a. The micro-structures 130 are disposed on the cutting portions 120. The quantity, the length, the position arranged at the base portion 110 of the cutting portions 120 can be varied and designed according to the required optical effect by the optical panel OP.

Then in step S130, the cutter 100 rotates to cut the optical panel OP, in which the optical panel OP after cutting as shown by FIG. 1 includes an optical element array OPA and a rubbing portion CL. The optical element array OPA is disposed on the surface S1 or S2 of the optical panel OP and extended in the first direction D1. The rubbing portion CL is disposed on the surface S1 or S2 of the optical panel OP and extended in the second direction D2.

It should be noted that the cutter 100 can perform cutting or surface processing on at least one surface S1 or S2 or all the surfaces S1 and S2 of the optical panel OP to form the optical element array OPA and the rubbing portion CL. The optical panel OP would get the optical characteristic structure such like the rubbing portion CL as the cutter 100 performs the fabrication of the optical panel OP.

Although there are three cutting portions 120 given in FIG. 3, but the real quantity of the cutting portions 120 can be adjusted depending on the application need and not limited to three ones. In addition, each cutting portion 120 in FIG. 3 is a bar-shape continuous structure, however the cutting portions 120 can be a plurality of discontinuous structures as well; the micro-structures 130 with the same figure as each other or different figures from each other are disposed respectively on each the cutting portion 120 so as to fabricate a cutter 100 combining many micro-structures 130 with specific configuration for cutting out the optical micro-structures OM with different functions.

By using the micro-structures 130 disposed on the cutting portions 120, the above-mentioned micro-structures 130 are able to perform cutting or scribing operation on the surface S1 or S2 of the optical panel OP contacting with the micro-structures 130 on the tangent line of the rotation direction R of the cutter 100 during high-speed rotation of the cutter 100. As a result, during cutting the optical panel OP, the optical element array OPA and the rubbing portion CL are spontaneously formed on the cutting surface of the optical panel OP, in which the shapes of the optical micro-structures OM of the optical element array OPA are complementary to the shapes of the micro-structures 130 of the cutter 100.

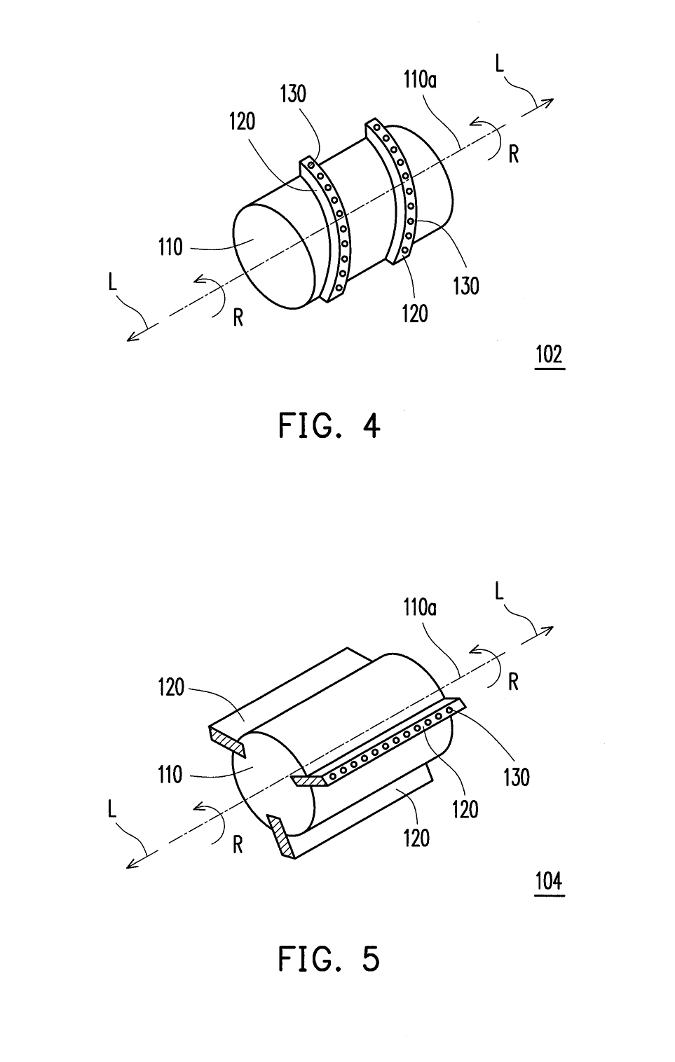

Referring to FIG. 3 again, the cutting portions 120 can be coaxially arranged along the extension direction L of the rotation axis 110a. In another embodiment, the cutting portions 120 can be arranged in other way. FIG. 4 is a schematic diagram of another cutter according to an embodiment of the invention. Referring to FIG. 4, the elements of the cutter 102 take the same notations as the same elements of the cutter 100 in FIG. 3. In the embodiment, the cutting portions 120 are spirally arranged along the extension direction L of the rotation axis 110a. By using the axial arrangement or the spiral arrangement, a plurality of micro-structures 130 on the cutting portions 120 can achieve cutting or surface scribing effect, so that the cutter 102 is suitable to perform cutting or surface processing on a workpiece with a larger area. In this way, the conventional problem of cutter damage caused by repeatedly cutting operations of a single cutter can be solved.

Referring to FIG. 3 again, the base portion 110 and the cutting portions 120 are integrated formed; that is to say, the cutting portions 120 can be directly formed on a cylinder (not shown) by using precision machining or electrical discharge machining (EDM), so that the base portion 110 and the cutting portions 120 are integrated formed.

In another embodiment, the base portion 110 and the cutting portions 120 can be connected to each other in other ways. FIG. 5 is a schematic diagram of yet another cutter according to an embodiment of the invention. Referring to FIG. 5, the elements of the cutter 104 take the same notations as the same elements of the cutter 100 in FIG. 3. In the embodiment, the base portion 110 and the cutting portions 120 are assembled to each other. In more details, the base portion 110 and the cutting portions 120 are separately fabricated, followed by fixing the cutting portions 120 onto the base portion 110 by using adhering or a specific latching structure, for example, a groove corresponding to the dimension of the cutting portions 120 is fabricated at the base portion 110, followed by sliding the cutting portions 120 into the groove so as to fix the cutting portions 120 onto the base portion 110 (not shown). In this way, the cutting portions 120 would not separate from the base portion 110 during high-speed rotation of the cutter 104.

FIG. 6 is a schematic diagram of micro-structures of a cutter according to an embodiment of the invention. Referring to FIG. 6, the shape of the micro-structures 130 are shown in an enlarged local region A of a cutting portion 120. In an embodiment, the above-mentioned micro-structures 130 are protruded from the cutting portion 120 and the shape of the micro-structures 130 is selected from a semicircular shape, a V-shape, a R-recess shape or a combination thereof, as shown as the semicircular shape micro-structures 130a, the V-shape micro-structures 130b and the R-recess shape micro-structures 130c and 130d in FIG. 6. The optical micro-structures OM concaved from the surface of the optical panel OP can be cut out on the surface of the optical panel OP by using the micro-structures 130 protruded from the cutting portions 120, as shown by FIG. 6.

FIG. 7 is a schematic diagram of micro-structures of a cutter according to another embodiment of the invention. Referring to FIG. 7, in another embodiment, the shape of the micro-structures 130 are shown in an enlarged local region B of a cutting portion 120, where the micro-structures 130 are concaved from the cutting portions 120 and the shape of the micro-structures 130 is selected from a semicircular shape, an inverted V-shape, a R-recess shape or a combination thereof, as shown as the semicircular shape micro-structures 130a, the V-shape micro-structures 130b and the R-recess shape micro-structures 130c and 130d in FIG. 7. The optical micro-structures OM protruded from the surface of the optical panel OP can be cut out on the surface of the optical panel OP by using the micro-structures 130 concaved from the cutting portions 120, as shown by FIG. 7.

The dimensions of the above-mentioned micro-structures 130a-130d one another are the same or different, for example, the R-recess shape micro-structures 130c and 130d have different dimensions from each other, or the semicircular shape micro-structures 130a have the same dimensions as each other. In addition, an interval between two adjacent micro-structures 130a-130d can be the same or different. People skilled in the art can combine different types and different dimensions of the micro-structures 130a-130d according to the design need. In this way, various micro-structures 130 can be directly combined on the cutting portions 120, so that the optical micro-structures OM with various shapes can be easily fabricated on the surface S1 or S2 of the optical panel during a single cutting operation, which can solve the conventional problem of too complex machining path and tool-exchanging sequence of the cutters caused by switching different cutters in the process.

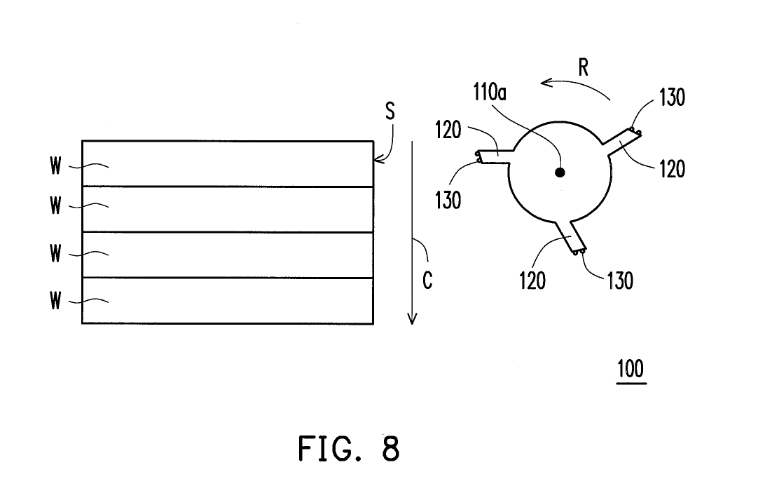

FIG. 8 is a schematic diagram showing performing cutting on a workpiece by using a cutter of the embodiment of the invention. Referring to FIG. 8, the cutter 100 can rotate in high-speed on the rotation direction R to cut a single workpiece W or a plurality of stacked workpieces W on the cutting direction C. It should be noted that since the micro-structures 130 are disposed on the cutting portions 120 of the cutter 100, surface micro-structures (not shown) can be formed on the surface S of the workpiece W during cutting the workpiece W.

Since the cutter 100 can fast cut a plurality of stacked workpieces W with the cutter 100, not only the process time of cutting the workpiece W is shortened, but also the required micro-structures 130 are formed on the surface S of the workpiece W. For example, when the workpiece W is an optical panel, after the cutting operation of the above-mentioned cutter 100, a plurality of optical micro-structures are formed on the light incident surface (surface S) of the optical panel, which advances the optical effect of the optical panel. In particular, for an optical panel with quite thin thickness, the cutter 100 can easily cut out the optical micro-structures on a side-surface of the optical panel.

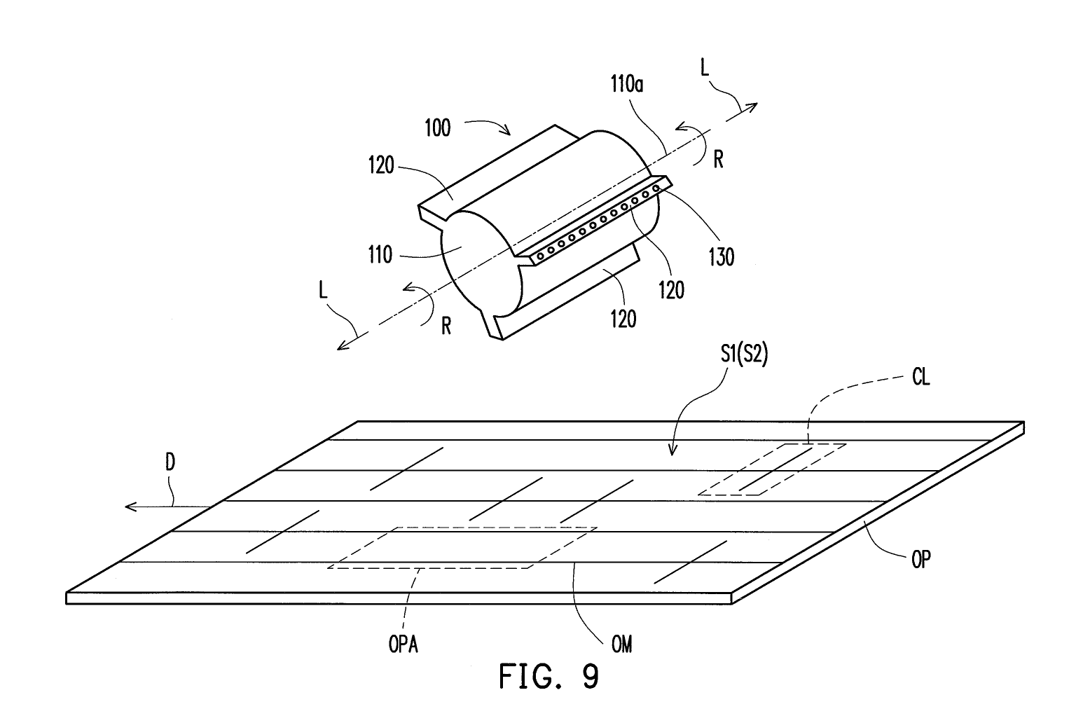

FIG. 9 is a schematic diagram showing performing surface processing on an optical panel by using a cutter of the embodiment of the invention. Referring to FIG. 9, during high-speed rotation of the cutter 100, the optical panel OP is conveyed on the transporting direction D of a conveyor belt (not shown) and the micro-structures 130 on the cutting portions 120 contact the surface S1 (upper surface) or S2 (lower surface) of the optical panel OP so as to cut out the optical element array OPA and the rubbing portion CL. The formed optical element array OPA is, for example, a lens micro-array able to provide the required optical effect, while the rubbing portion CL is for hazing light.

In addition, the three-dimensional image display is gradually developed now. According to visualization characteristic of human naked eyes, when the left and right eyes observe the two images of a same image content but with different parallaxes, the naked eyes would see a three-dimensional image by means of overlapping the two images with each other and interpreting the overlapped images. For the application, the above-mentioned cutter 100 can be used to form optical micro-structures of three-dimensional image.

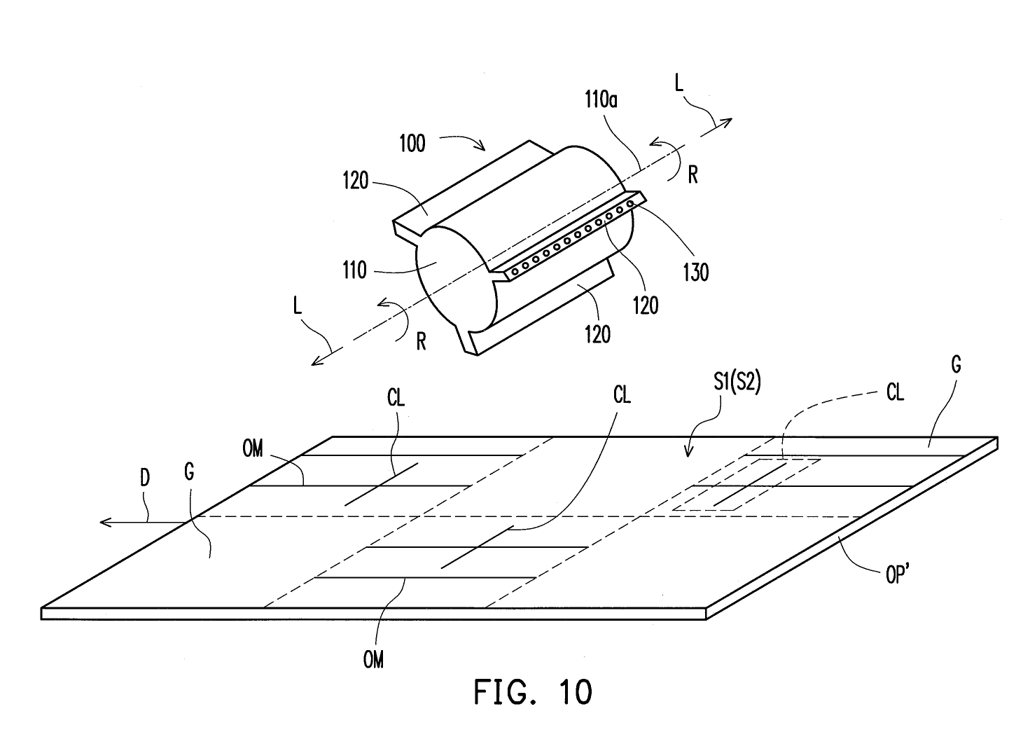

FIG. 10 is a schematic diagram showing performing surface processing on another optical panel by using a cutter of the embodiment of the invention. Referring to FIG. 10, an optical panel OP′ has a surface S1 or S2. The optical panel OP′ includes a plurality of optical micro-structures OM and a rubbing portion CL. The optical micro-structures OM and the rubbing portion CL are distributed on the surface S1 or S2 of the optical panel OP′, in which the surface S1 or S2 includes an upper surface or a lower surface of the optical panel OP′.

The optical panel OP′ is similar to the above-mentioned optical panel OP, and the relevant depiction is omitted to describe. It should be noted that, the above-mentioned optical panel OP′ in FIG. 10 has a plurality of distribution regions G, and the optical micro-structures OM and the rubbing portion CL are regularly or irregularly disposed in the distribution regions G. In other words, the optical element array OPA and the rubbing portion CL can be distributed at the same blocks or different blocks (i.e., the distribution regions G).

Referring to FIG. 10 again, the optical micro-structures OM and the rubbing portion CL can be fabricated at a part of the distribution regions G, while the rest part of the distribution regions G can have no optical micro-structures OM and rubbing portion CL. The above-mentioned optical panel OP′ can be cut out by means of design of the micro-structures 130 of the cutter 100 and making the micro-structures 130 contacted or not contacted with the surface S1 or S2 of the optical panel OP′.

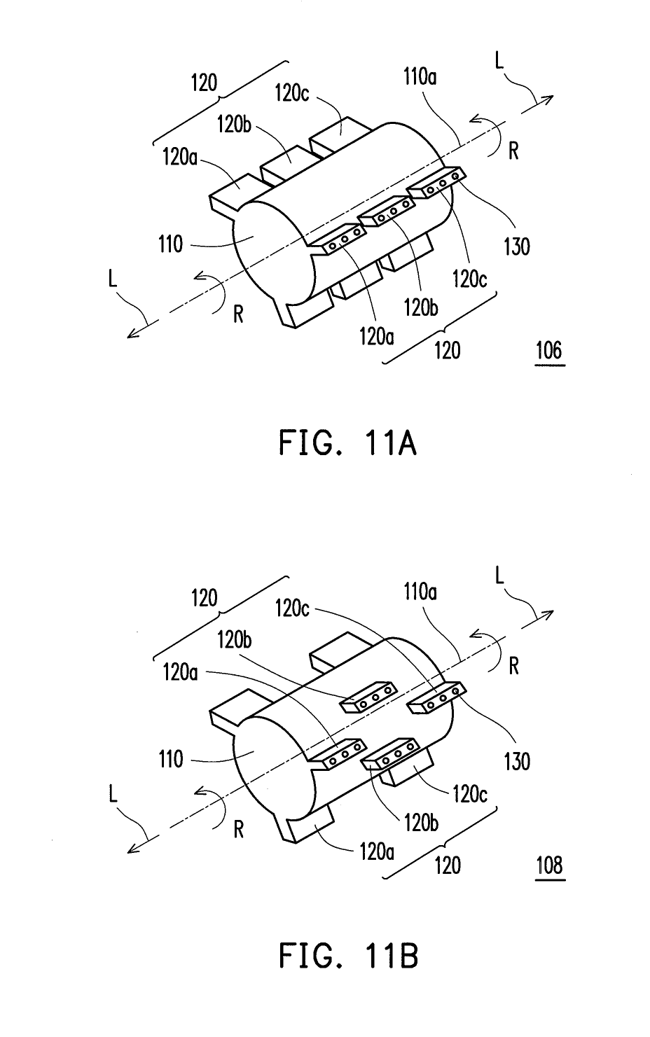

FIG. 11A is a schematic diagram of a cutter according to yet another embodiment of the invention, where the total length of a plurality of cutting portions 120a, 120b and 120c is not equal to the length of the base portion 110. The cutting portions 120a, 120b and 120c can be assembled to each other (through an unshown locking structure), so that the cutting portions 120a, 120b and 120c form a bar-shape cutting shape 120 of FIG. 3 and the total length thereof is equal to the length of the base portion 110. The cutting portions 120 of the cutter 100 as shown by FIG. 6 can be continuously (FIG. 4) or discontinuously (FIG. 11A) disposed on the base portion for fabrication; when the cutting portions 120 are discontinuously disposed on the base portion, the cutting portions are multiple and assembled on the base portion along a same axis direction.

FIG. 11B is a schematic diagram of a cutter according to yet another embodiment of the invention. Referring to FIG. 11B, the elements of the cutter 108 take the same notations as the same elements of the cutter 100 in FIG. 3. In the embodiment, the cutting portions 120 are discontinuously disposed on the base portion 110, and the cutting portions 120 are multiple (cutting portions 120a, 120b and 120c) and assembled on the base portion 110 along different axis directions.

It should be noted that by means of discontinuously disposing the cutting portions and assembling the multiple cutting portions, the fabrication flow of the cutter 106 has more flexibility.

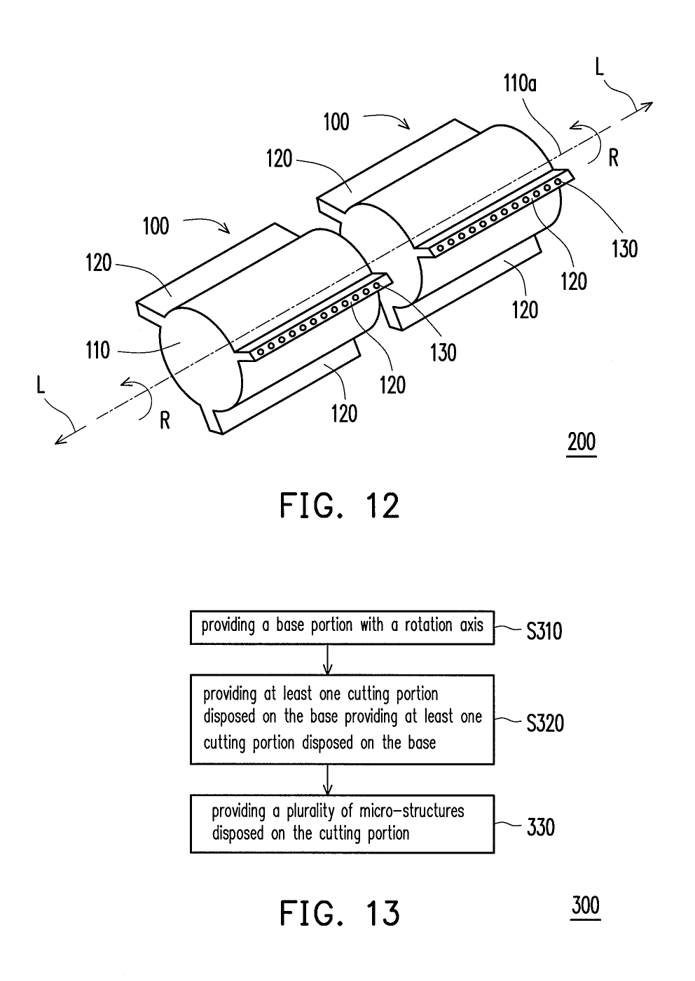

FIG. 12 is a schematic diagram of a cutter module according to an embodiment of the invention. Referring to FIG. 12, a cutter module 200 includes a plurality of above-mentioned cutters 100, in which the cutters 100 are arranged on the extension direction L of the rotation axis 110a.

As shown by FIGS. 9 and 10, only one cutter 100 is given for surface processing. However, the invention is not limited to one cutter 100. In more details, when the area of the optical panel OP is increased, the multiple cutters 100 can form a cutter module 200 as shown by FIG. 10 to perform cutting or surface processing operation on the optical panel OP with a larger area.

In addition, a used put the cutters together to form a cutter module 200 corresponding to the optical panel OP with a specific dimension so as for cutting or surface processing on the optical panel OP with the specific dimension. When any one cutter 100 in the cutter module 200 is broken, the damaged cutter 100 can be directly changed, which facilitates advancing the maintenance efficiency.

In particular, the cutters 100-104 with various different micro-structures 130 can be combined to form a cutter module 200 so as to fabricate optical micro-structures OM with various figures.

### Fabrication Method of Cutter

FIG. 13 is a flowchart illustrating a fabricating method of cutter according to one embodiment of the present invention. Referring to FIGS. 13 and 3, the fabrication method 300 of cutter includes steps S310-S330. First in step S310, a base portion 110 is provided, in which the base portion 110 has a rotation axis 110a. The material of the base portion 110 includes high-hardness metal, diamond or other appropriate materials. The base portion 110 is, preferably, a cylinder.

Next in step S320, at least one cutting portion 120 is provided and disposed on the base portion 110 and arranged along the extension direction L of the rotation axis 110a. At least one cutting portion 120 is cut out at the base portion 110 by using EDM or machining process; or, a recess (not shown) can be fabricated at the base portion 110 and a cutting portion 120 is additionally fabricated, followed by assembling the cutting portion 120 onto the recess of the base portion 110. The base portion 110 and the cutting portion 120 can be integrated formed or assembled after separately fabricating. The cutting portions 120 can be continuously or discontinuously disposed on the base portion 110, and when the cutting portions 120 are discontinuously disposed on the base portion 110, the cutting portions 120 are multiple 120a, 120b and 120c and assembled on the base portion 110 along a same axis direction or different axis directions.

Then in step S330, a plurality of micro-structures 130 are provided and disposed on the cutting portion 120. The micro-structures 130 can be formed on the cutting portions 120 first and then the cutting portions 120 with the micro-structures 130 are assembled at the base portion 110; or, an EDM or machining operation is performed on the cutting portions 120 on the integrated formed base portion 110 and cutting portions 120 to fabricate the micro-structures 130.

In the above-mentioned fabrication method 300 of cutter, various implementations of the fabricated cutters 100-106 are depicted, which is omitted to describe. It should be noted that the sequence between the above-mentioned three steps S310-S330 can be changed so as to fabricate the above-mentioned cutters 100-106.

In summary, the optical panel and the fabrication method thereof have at least following advantages:

By using the cutter of the embodiments to perform cutting or surface processing operation on the optical panel, a plurality of figures of the optical micro-structures and rubbing portion can be formed on the surface of the optical panel, in which the rubbing portion provides an optical effect of hazing light.

During cutting or surface processing, the multiple micro-structures disposed on the cutting portion can cut the optical panel, which advances the machining speed of the cutter and increases the cutter lifetime. In comparison with the conventional thermal imprinting method, the optical micro-structures of the above-mentioned optical panel are not affected by hot-expansion and cold-shrinking nature after cooling by using the above-mentioned cutter to fabricate the optical panel. Thus, the dimension precision of the optical micro-structures is advanced.

By using various micro-structures formed on the cutting portion, the optical micro-structures with required shapes can be formed on the optical panel, so as to obtain an optical panel with diffusion effect, light-collecting effect or brightness enhance effect.

The cutter, cutter module and fabrication method of cutter in the invention have at least following advantages:

The cutting portion in the cutter is arranged along the extension direction of the rotation axis of the base portion and the micro-structures are formed on the cutting portion. In this way, during cutting or surface processing, the multiple micro-structures disposed on the cutting portion can cut the workpiece, which advances the machining speed of the cutter and increases the cutter lifetime. In addition, by using various micro-structures formed on the cutting portion, any required micro-structures can be formed on the workpiece, which is suitable for machining micro-structures with special shapes. Various different cutters can comprise a cutter module to suit the cutting or surface processing operation of a workpiece with certain dimensions, and, when a single cutter is damaged, the cutter is easily changed. The fabrication method of cutter has advantage of process simplicity and is able to fabricate a cutter to form the micro-structures on the surface of the workpiece during cutting or surface processing on the workpiece.

It will be apparent to those skilled in the art that the descriptions above are several preferred embodiments of the invention only, which does not limit the implementing range of the invention. Various modifications and variations can be made to the structure of the invention without departing from the scope or spirit of the invention.

What is claimed is:

1. An optical panel having a surface which has a first direction and a second direction and an included angle is formed between the first direction and the second direction, the optical panel comprising:
an optical element array, disposed on the surface of the optical panel and extended in the first direction; and
a rubbing portion, disposed on the surface of the optical panel and extended in the second direction,
wherein the surface comprises an upper surface of the optical panel, a lower surface of the optical panel and a combination thereof.

2. The optical panel as claimed in claim 1, wherein the rubbing portion is distributed on a same horizontal/vertical base line of the surface or on different horizontal/vertical base lines of the surface.

3. The optical panel as claimed in claim 1, wherein the included angle is 90±10 degrees.

4. The optical panel as claimed in claim 1, wherein the optical element array comprises: a plurality of optical micro-structures protruded from the surface of the optical panel, and the shape of the optical micro-structures is selected from a semicircular shape, a V-shape, a R-recess shape or a combination thereof.

5. The optical panel as claimed in claim 1, wherein the optical element array comprises: a plurality of optical micro-structures concaved from the surface of the optical panel, and the shape of the optical micro-structures is selected from a semicircular shape, a V-shape, a R-recess shape or a combination thereof.

6. The optical panel as claimed in claim 1, wherein the optical element array comprises: a plurality of optical micro-structures, wherein dimensions of the optical micro-structures one another are the same or different.

7. The optical panel as claimed in claim 1, wherein the optical element array comprises: a plurality of optical micro-structures, wherein an interval between two adjacent optical micro-structures is the same or different.

8. The optical panel as claimed in claim 1, wherein the optical panel comprises diffusion sheet, diffusion plate, prism sheet or brightness-enhancing sheet.

9. An optical panel having a surface, the optical panel comprising:
a plurality of optical micro-structures, distributed on the surface of the optical panel; and
a rubbing portion, distributed on the surface of the optical panel,
wherein the surface comprises an upper surface of the optical panel, a lower surface of the optical panel and a combination thereof.

10. The optical panel as claimed in claim 9, wherein the optical panel has a plurality of distribution regions, and the optical micro-structures and the rubbing portion are regularly or irregularly disposed in the distribution regions.

11. The optical panel as claimed in claim 9, wherein the rubbing portion is distributed on a same horizontal/vertical base line of the surface or on different horizontal/vertical base lines of the surface.

12. The optical panel as claimed in claim 9, wherein the optical micro-structures are protruded from the surface of the optical panel, and the shape of the optical micro-structures is selected from a semicircular shape, a V-shape, a R-recess shape or a combination thereof.

13. The optical panel as claimed in claim 9, wherein the optical micro-structures are concaved from the surface of the optical panel, and the shape of the optical micro-structures is selected from a semicircular shape, a V-shape, a R-recess shape or a combination thereof.

14. The optical panel as claimed in claim 9, wherein dimensions of the optical micro-structures one another are the same or different.

15. The optical panel as claimed in claim 9, wherein an interval between two adjacent optical micro-structures is the same or different.

16. The optical panel as claimed in claim 9, wherein the optical panel comprises diffusion sheet, diffusion plate, prism sheet or brightness-enhancing sheet.
